(19) United States
(12) Patent Application Publication
(10) Pub. No.: US 2023/0142229 A1
(43) Pub. Date: May 11, 2023

(54) MAGNETIC TAPE DEVICE AND METHOD OF OPERATING MAGNETIC TAPE DEVICE

(71) Applicant: FUJIFILM Corporation, Tokyo (JP)

(72) Inventors: Ren ISHIKAWA, Kanagawa (JP); Yuto MURATA, Kanagawa (JP)

(73) Assignee: FUJIFILM Corporation, Tokyo (JP)

(21) Appl. No.: 18/152,527

(22) Filed: Jan. 10, 2023

Related U.S. Application Data
(63) Continuation of application No. PCT/JP21/15583, filed on Apr. 15, 2021.

(30) Foreign Application Priority Data
Jul. 20, 2020 (JP) 2020-123831

(51) Int. Cl. G11B 21/10

(52) U.S. Cl. CPC G11B 21/103

(57) ABSTRACT

Provided is a magnetic tape device including: a magnetic head having a magnetic element that acts on a magnetic layer formed on a front surface of a magnetic tape; and a position adjusting actuator that adjusts a position of the magnetic element in a normal direction of the front surface by moving the magnetic head; and a processor that controls an operation of the position adjusting actuator.

### CROSS REFERENCE TO RELATED APPLICATIONS

This application is a continuation application of International Application No. PCT/JP2021/015583 filed on Apr. 15, 2021, the disclosure of which is incorporated herein by reference in its entirety. Further, this application claims priority from Japanese Patent Application No. 2020-123831 filed on Jul. 20, 2020, the disclosure of which is incorporated herein by reference in its entirety.

### BACKGROUND

### 1. Technical Field

The technology of the present disclosure relates to a magnetic tape device and a method of operating a magnetic tape device.

### 2. Description of the Related Art

Various magnetic tape devices that cause a magnetic element of a magnetic head to act on a magnetic layer formed on a front surface of a magnetic tape to record data on the magnetic layer and/or read data recorded on the magnetic layer have been proposed. For example, JP1999-126318A (JP-H11-126318A) discloses a magnetic tape device that adjusts a position of a magnetic element in a width direction of a magnetic tape by using a piezoelectric element.

### SUMMARY

Although the magnetic layer is flattened, the front surface of the magnetic tape has irregularities on the order of several nm to several tens of nm. In addition, the magnetic tape has positional variation on the order of several tens of nm to several µm in a normal direction of the front surface, due to, for example, adhesion of foreign matter to the magnetic head that has resulted from scrapes of the magnetic layer through a swell during running caused by eccentricity of a guide roller that guides the running thereof, through vibration caused by friction with the guide roller, or through contact with the magnetic element, and/or that has occurred for some other reason. Further, the magnetic element may be worn by an abrasive prescribed for the magnetic layer, and a positional relationship between the magnetic layer and the magnetic element in the normal direction may change with time.

Such a variation in the positional relationship between the magnetic layer and the magnetic element in the normal direction destabilizes recording and/or reading data. Therefore, it is necessary to adjust the position of the magnetic element in the normal direction. However, JP1999-126318A (JP-H11-126318A) discloses adjusting the position of the magnetic element in the width direction of the magnetic tape, but does not disclose adjusting the position of the magnetic element in the normal direction.

One embodiment according to the technology of the present disclosure provides a magnetic tape device and a method of operating a magnetic tape device capable of maintaining a positional relationship between a magnetic layer and a magnetic element in a normal direction of a front surface of a magnetic tape.

According to the present disclosure, there is provided a magnetic tape device comprising: a magnetic head having a magnetic element that acts on a magnetic layer formed on a front surface of a magnetic tape; and a position adjusting actuator that adjusts a position of the magnetic element in a normal direction of the front surface by moving the magnetic head; and a processor that controls an operation of the position adjusting actuator.

It is preferable that the magnetic head causes the magnetic element to act in proximity to the magnetic layer.

It is preferable that the magnetic head has a width smaller than a width of the magnetic tape.

It is preferable that the position adjusting actuator is a piezoelectric element.

It is preferable that the processor controls the operation of the position adjusting actuator on the basis of variation profile data representing a variation of the magnetic tape in the normal direction.

It is preferable that a pair of support members on which the front surface is slid is further provided, the pair of support members being disposed on both sides of the magnetic tape in a running direction with the magnetic head interposed therebetween.

It is preferable that a plurality of data bands on which data is recorded, and a plurality of servo bands on which a plurality of servo patterns used for servo control to move the magnetic head in a width direction of the magnetic tape are recorded are formed in the magnetic layer, and the magnetic head includes, as the magnetic element, a data element that acts on the data band and a servo pattern reading element that reads the servo patterns.

It is preferable that the data element includes a data recording element that records the data on the magnetic layer, and a data reading element that reads the data recorded on the magnetic layer.

According to the present disclosure, there is provided a method of operating a magnetic tape device, comprising: adjusting a position of a magnetic element of a magnetic head in a normal direction of a front surface of a magnetic tape by controlling an operation of a position adjusting actuator to move the magnetic head; and causing the magnetic element to act on a magnetic layer formed on the front surface.

According to the technology of the present disclosure, it is possible to provide a magnetic tape device and a method of operating the magnetic tape device capable of maintaining a positional relationship between a magnetic layer and a magnetic element in a normal direction of a front surface of a magnetic tape.

### BRIEF DESCRIPTION OF THE DRAWINGS

Exemplary embodiments according to the technique of the present disclosure will be described in detail based on the following figures, wherein:

FIG. 1 is a diagram showing an example of a magnetic tape device;

FIG. 2 is an enlarged view of a vicinity of a magnetic head;

FIG. 3 is a plan view of a magnetic tape as viewed from sides of the magnetic head and of a support member;

FIG. 4 is an exploded perspective view of a suspension and the magnetic head;

FIG. 5 is a perspective view of a piezoelectric bimorph element;

FIGS. 6A to 6C are diagrams showing a situation in which a position of a magnetic element in a normal direction is adjusted by the piezoelectric bimorph element, in which FIG. 6A shows a case where the magnetic tape is displaced in a direction of the magnetic head from a regular position and the piezoelectric bimorph element is bent in a direction away from the magnetic tape, FIG. 6B shows a case where the magnetic tape is located at the regular position, and FIG. 6C shows a case where the magnetic tape is displaced in a direction opposite to the magnetic head from the regular position and the piezoelectric bimorph element is bent in a direction of approaching the magnetic tape;

FIG. 7 is an enlarged view of the vicinity of the magnetic head;

FIG. 8 is a diagram showing a correspondence relationship between a data element and a data track;

FIG. 9 is an enlarged view of the data element;

FIG. 10 is a block diagram showing a computer constituting a control unit;

FIG. 11 is a block diagram of a CPU;

FIG. 12 is a diagram showing variation profile data;

FIG. 13 is a flowchart showing an operation procedure of the magnetic tape device;

FIG. 14 is a diagram showing an example in which a laminated piezoelectric element is used; and

FIGS. 15A and 15B are diagrams showing a situation in which the position of the magnetic element in the normal direction is adjusted by the laminated piezoelectric element, in which FIG. 15A shows a case where the magnetic tape is displaced in the direction of the magnetic head from the regular position and the laminated piezoelectric element contracts, and FIG. 15B shows a case where the magnetic tape is displaced in the direction opposite to the magnetic head from the regular position and the laminated piezoelectric element expands.

### DETAILED DESCRIPTION

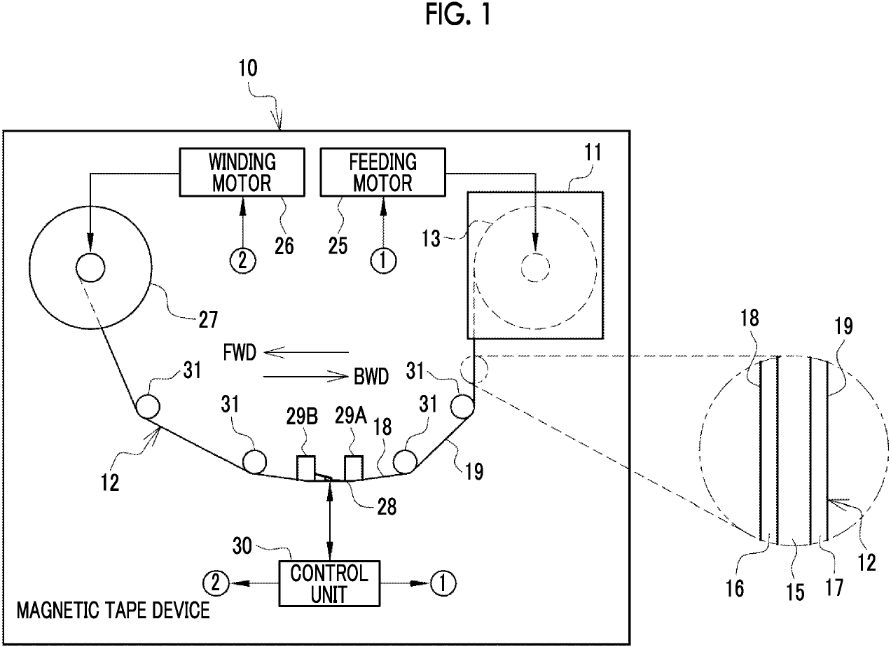

In FIG. 1, a cartridge 11 is loaded into a magnetic tape device 10. A cartridge reel 13 on which a magnetic tape 12 is wound is accommodated in the cartridge 11. The magnetic tape device 10 records data on the magnetic tape 12 fed out from the cartridge reel 13. Further, the magnetic tape device 10 reads data recorded on the magnetic tape 12.

The magnetic tape 12 has, for example, a configuration in which a magnetic layer 16 and a back coating layer 17 are formed on a base film 15. In the magnetic tape 12, a surface on which the magnetic layer 16 is formed is a front surface 18 of the magnetic tape 12. On the other hand, a surface on which the back coating layer 17 is formed is a back surface 19 of the magnetic tape 12. Data is recorded on the magnetic layer 16. The magnetic layer 16 contains ferromagnetic powder. As the ferromagnetic powder, ferromagnetic powder generally used in the magnetic layer of various magnetic recording media can be used. Preferable specific examples of the ferromagnetic powder can include hexagonal ferrite powder. As the hexagonal ferrite powder, for example, ferromagnetic powder, such as hexagonal strontium ferrite powder or hexagonal barium ferrite powder, can be used. The back coating layer 17 contains, for example, non-magnetic powder, such as carbon black. The base film 15 is also called a support and is formed of, for example, polyethylene terephthalate, polyethylene naphthalate, or polyamide. A non-magnetic layer may be formed between the base film 15 and the magnetic layer 16.

The magnetic tape device 10 comprises a feeding motor 25, a winding motor 26, a winding reel 27, a magnetic head 28, support members 29A and 29B, a control unit 30, and the like. The feeding motor 25 rotates the cartridge reel 13 provided in the cartridge 11 under the control of the control unit 30. The magnetic tape 12 fed out from the cartridge reel 13 is wound on the winding reel 27. Further, the magnetic tape 12 wound up on the winding reel 27 is rewound on the cartridge reel 13. The winding motor 26 rotates the winding reel 27 under the control of the control unit 30.

The magnetic tape 12 runs in a feed direction FWD or a rewind direction BWD while being guided by a plurality of guide rollers 31 with the drive of the feeding motor 25 and the winding motor 26. The feed direction FWD is a direction from the cartridge reel 13 toward the winding reel 27. The rewind direction BWD is, on the contrary, a direction from the winding reel 27 toward the cartridge reel 13. The feed direction FWD and the rewind direction BWD are an example of the “running direction” according to the technology of the present disclosure. Further, in the magnetic tape 12, the rotational speed and the rotational torque of the feeding motor 25 and the winding motor 26 are adjusted so that the tension during running and the running speed are adjusted to appropriate values.

The magnetic head 28 is disposed on the front surface 18 side of the magnetic tape 12 in order to access the magnetic layer 16. The magnetic head 28 records data on the magnetic layer 16. In addition, the magnetic head 28 reads data recorded on the magnetic layer 16.

The magnetic head 28 operates in a case where the magnetic tape 12 is running in the feed direction FWD. In other words, the magnetic head 28 operates in a case where the magnetic tape 12 is fed out from the cartridge reel 13. Further, the magnetic head 28 operates in a case where the magnetic tape 12 is running in the rewind direction BWD. In other words, the magnetic head 28 operates in a case where the magnetic tape 12 is rewound on the cartridge reel 13.

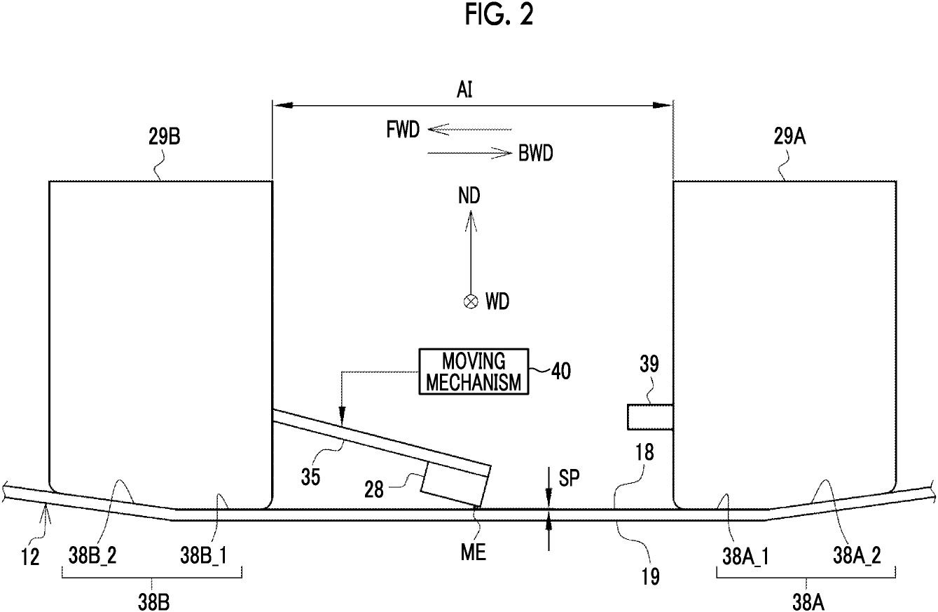

The magnetic head 28 is a small magnetic head, such as a magnetic head used for a hard disk drive. The magnetic head 28 is provided at a distal end of a suspension 35 (see FIG. 2 and the like). A proximal end of the suspension 35 is movably attached to, for example, the support member 29B. The magnetic head 28 may be retracted to a standby position separated from the magnetic tape 12 during non-operation.

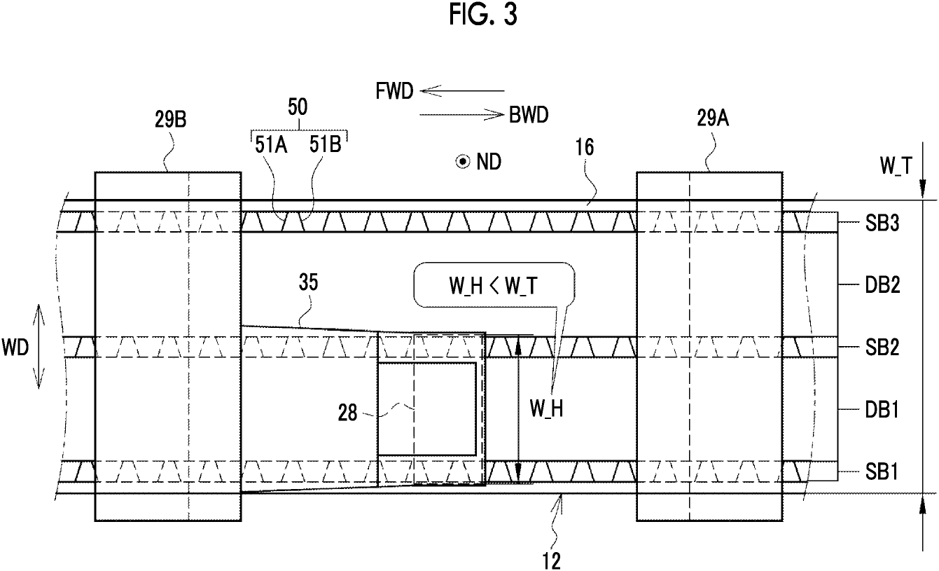

The support members 29A and 29B are disposed on the front surface 18 side of the magnetic tape 12 like the magnetic head 28. The support members 29A and 29B have a substantially rectangular shape (see also FIG. 2 and FIG. 3) and are disposed on both sides in the feed direction FWD and the rewind direction BWD with the magnetic head 28 interposed therebetween. The support members 29A and 29B support the magnetic tape 12 from the front surface 18 side.

As shown in the enlarged view of FIG. 2, the support member 29A has a sliding surface 38A, and the support member 29B has a sliding surface 38B. Corners of the sliding surfaces 38A and 38B are subjected to R chamfering. The sliding surface 38A has a first surface 38A_1 and a second surface 38A_2 that is inclined with respect to the first surface 38A_1. Similarly, the sliding surface 38B has a first surface 38B_1 and a second surface 38B_2 that is inclined with respect to the first surface 38B_1. The front surface 18 of the magnetic tape 12 is slid on the sliding surfaces 38A and 38B. That is, the magnetic tape 12 runs while sliding the front surface 18 on the sliding surfaces 38A and 38B. The magnetic tape 12 runs such that the center in the width direction WD (see also FIG. 3 and the like, a direction perpendicular to a paper surface in FIG. 2) thereof coincides with the centers of the support members 29A and 29B. The term “coincide” as used herein indicates a coincidence in a sense including an error generally allowed in the technical field to which the technology of the present disclosure belongs, in addition to the complete coincidence.

The support members 29A and 29B are disposed at positions mirror-symmetrical to each other with respect to the magnetic head 28, more specifically, with respect to a magnetic element ME of the magnetic head 28. A disposition interval AI between the support members 29A and 29B is, for example, 2 mm to 20 mm.

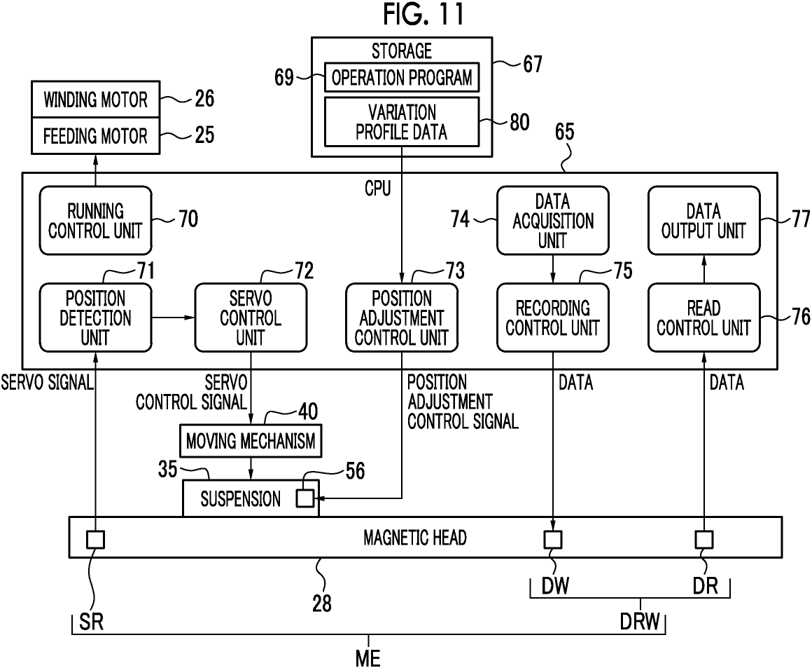

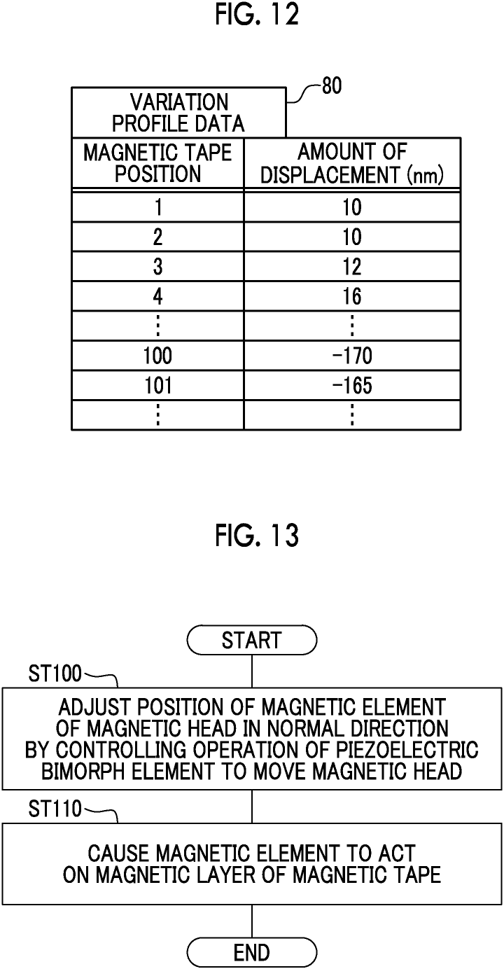

A distance sensor 39 is attached to the support member 29A. The distance sensor 39 is a sensor for acquiring variation profile data 80 (see FIGS. 11 and 12), which will be described later, and measures a distance to the front surface 18 of the magnetic tape 12.

Reference numeral ND indicates a normal direction of the front surface 18 of the magnetic tape 12. In the vicinity of the magnetic head 28, the normal direction ND is a direction orthogonal to the feed direction FWD and the rewind direction BWD, and to the width direction WD of the magnetic tape 12. In addition, the normal direction ND is a direction parallel to a direction in which the magnetic tape 12 and the magnetic element ME face each other. Reference numeral SP indicates a spacing which is a gap between the magnetic layer 16 and the magnetic element ME. Here, “orthogonal” indicates orthogonality in the sense including an error generally allowed in the technical field to which the technology of the present disclosure belongs, and an error to the extent that does not violate the gist of the technology of the present disclosure, in addition to the complete orthogonality.

A moving mechanism 40 is connected to the suspension 35. The moving mechanism 40 moves the suspension 35, that is, the magnetic head 28, in the width direction WD of the magnetic tape 12. The moving mechanism 40 includes, for example, an actuator, such as a voice coil motor or a piezoelectric element.

In FIG. 3 in which the magnetic tape 12 is viewed from the sides of the magnetic head 28 and of the support members 29A and 29B, a width W_H of the magnetic head 28 is smaller than a width W_T of the magnetic tape 12. Specifically, the width W_H of the magnetic head 28 is about ½ of the width W_T of the magnetic tape 12. The width W_T of the magnetic tape 12 is, for example, 12.65 mm, and the width W_H of the magnetic head 28 is, for example, 6.5 mm to 7.0 mm. Incidentally, other sizes such as the depth and the height of the magnetic head 28 are also smaller than the width W_T of the magnetic tape 12 and are, for example, about several mm.

The magnetic layer 16 has three servo bands SB1, SB2, and SB3 and two data bands DB1 and DB2 on which data is recorded. The servo bands SB1 to SB3 and the data bands DB1 and DB2 are formed along the feed direction FWD and the rewind direction BWD (a length direction of the magnetic tape 12). The servo bands SB1 to SB3 are arranged at equal intervals along the width direction WD of the magnetic tape 12. The data band DB1 is disposed between the servo bands SB1 and SB2, and the data band DB2 is disposed between the servo bands SB2 and SB3. That is, the servo bands SB1 to SB3 and the data bands DB1 and DB2 are alternately arranged along the width direction WD of the magnetic tape 12.

A servo pattern 50 is recorded on the servo bands SB1 to SB3. A plurality of the servo patterns 50 are provided at equal intervals along, for example, the feed direction FWD and the rewind direction BWD. The servo pattern 50 is composed of a pair of linearly symmetric magnetization regions 51A and 51B that are non-parallel to each other and that form a predetermined angle. The magnetization region 51A is tilted toward the rewind direction BWD side, and the magnetization region 51B is tilted toward the feed direction FWD side. The servo pattern 50 is used for servo control to move the magnetic head 28 in the width direction WD of the magnetic tape 12 through the moving mechanism 40.

The magnetic head 28 records data on the data band DB1 and reads data recorded on the data band DB1, in a case where the magnetic tape 12 is running in the feed direction FWD. In addition, the magnetic head 28 reads the servo patterns 50 recorded on the servo bands SB1 and SB2 in a case where the magnetic tape 12 is running in the feed direction FWD.

Further, the magnetic head 28 records data on the data band DB2 and reads data recorded on the data band DB2, in a case where the magnetic tape 12 is running in the rewind direction BWD. Further, the magnetic head 28 reads the servo patterns 50 recorded on the servo bands SB2 and SB3 in a case where the magnetic tape 12 is running in the rewind direction BWD.

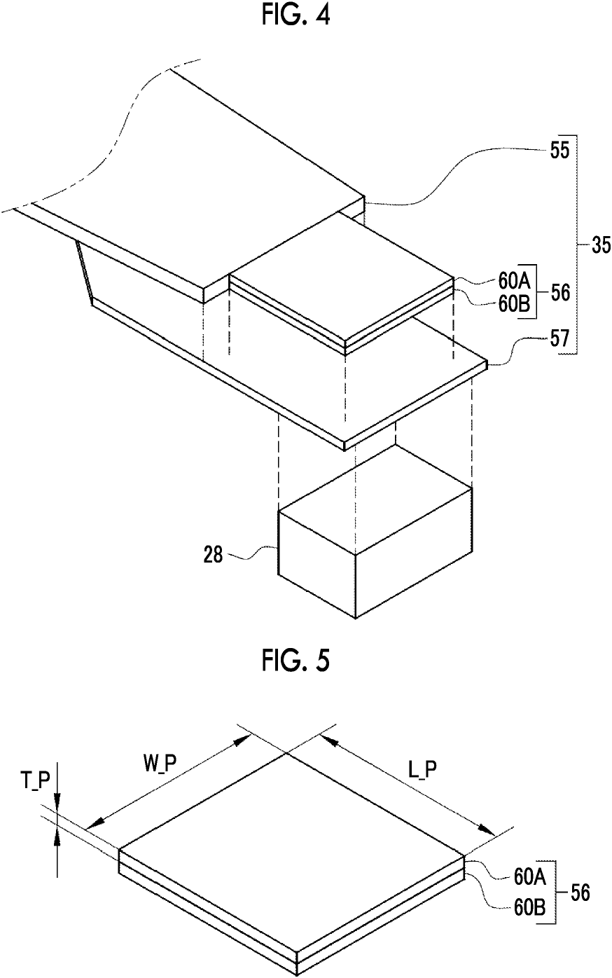

As shown in FIG. 4 as an example, the suspension 35 has a load beam 55, a piezoelectric bimorph element 56, a flexure 57, and the like. The load beam 55 is a thin flat plate made of metal having relatively high stiffness. The load beam 55 is attached to a base plate whose proximal end is not shown, and is connected to an actuator, such as a voice coil motor of the moving mechanism 40, via the base plate. The load beam 55 is formed to have a length slightly shorter than that of the flexure 57, and the piezoelectric bimorph element 56 is fixed to a distal end of the load beam 55.

The piezoelectric bimorph element 56 has a configuration in which two flat plate-shaped piezoelectric bodies 60A and 60B are bonded to each other. One of the piezoelectric bodies 60A and 60B expands and the other contracts, in a case where a voltage is applied. The piezoelectric bimorph element 56 is an element that is bent by the expansion and contraction of the piezoelectric bodies 60A and 60B to move a target. The piezoelectric bodies 60A and 60B are, for example, lead zirconate titanate (PZT; Pb(Zr,Ti)O₃). The piezoelectric body 60B side of the piezoelectric bimorph element 56 is attached to the flexure 57. The piezoelectric bimorph element 56 is an example of the “position adjusting actuator” and the “piezoelectric element” according to the technology of the present disclosure.

The flexure 57 is a thin flat plate made of metal having relatively low stiffness. Therefore, the flexure 57 functions as a leaf spring. The magnetic head 28 is attached to a surface of the flexure 57 opposing a surface to which the piezoelectric bimorph element 56 is attached.

As shown in FIG. 5 as an example, a length L_P and a width W_P of each of the piezoelectric bodies 60A and 60B are both several mm. A thickness T_P of each of the piezoelectric bodies 60A and 60B is several tens of µm.

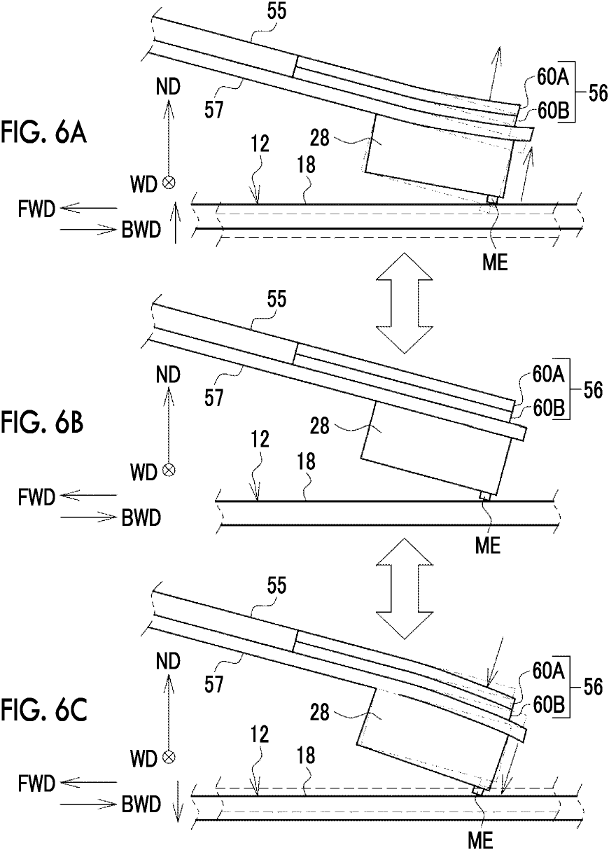

As shown in FIGS. 6A to 6C as an example, the piezoelectric bimorph element 56 bends the distal end of the flexure 57 with the expansion and contraction of the piezoelectric bodies 60A and 60B to move the magnetic head 28, thereby adjusting the position of the magnetic element ME in the normal direction ND. The piezoelectric bimorph element 56 operates so as to keep the spacing SP constant, under the control of the control unit 30. Specifically, in a case where the position of the magnetic tape 12 is displaced in a direction of the magnetic head 28 from a regular position shown in FIG. 6B, the piezoelectric bimorph element 56 is bent in a direction away from the magnetic tape 12 as shown in FIG. 6A. On the other hand, in a case where the position of the magnetic tape 12 is displaced in a direction opposite to the magnetic head 28 from the regular position shown in FIG. 6B, the piezoelectric bimorph element 56 is bent in a direction of approaching the magnetic tape 12 as shown in FIG. 6C.

A bending amount ΔL of the piezoelectric bimorph element 56 in one direction is represented by Equation (1). Here, d denotes a piezoelectric strain constant, and V denotes an applied voltage.

$$Δ \text{L=} \frac{3}{4} {\left(\frac{\text{L} \_ \text{P}}{\text{T} \_ \text{P}}\right)}^{2} ⋅ \text{d} ⋅ \text{V}$$

For example, a case where the length L_P and the width W_P of each of the piezoelectric bodies 60A and 60B are both 1 mm and the thickness T_P of each of the piezoelectric bodies 60A and 60B is 50 µm is considered. In a case where the piezoelectric strain constant d of each of the piezoelectric bodies 60A and 60B is, for example, 200 × 10⁻¹² m/V, and a voltage of, for example, 20 V is applied to the piezoelectric bodies 60A and 60B, the bending amount ΔL is 1.2 µm according to Equation (1).

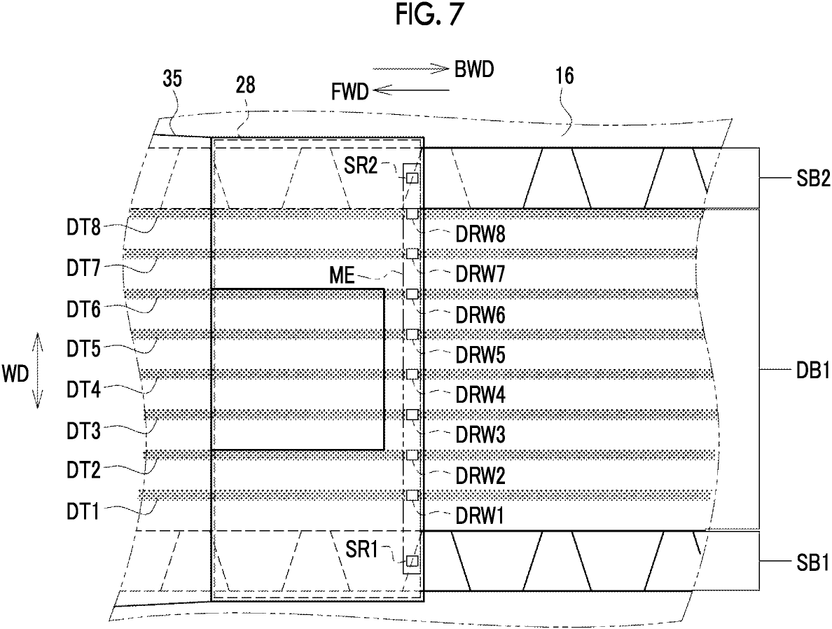

In FIG. 7, which is an enlarged view of the vicinity of the magnetic head 28, the magnetic head 28 has a plurality of magnetic elements ME that are provided on a surface facing the magnetic layer 16 and that act on the magnetic layer 16. The magnetic head 28 causes the magnetic element ME to act on the magnetic layer 16 by bringing the magnetic element ME close to the magnetic layer 16 with the spacing SP on the order of several nm therebetween.

The magnetic element ME has two servo pattern reading elements SR1 and SR2, and eight data elements DRW1, DRW2, DRW3, DRW4, DRW5, DRW6, DRW7, and DRW8. Hereinafter, in a case where there is no need to make a particular distinction, the servo pattern reading elements SR1 and SR2 are collectively denoted as a servo pattern reading element SR, and the data elements DRW1 to DRW8 are collectively denoted as a data element DRW.

The servo pattern reading element SR1 is provided at a position corresponding to the servo band SB1, and the servo pattern reading element SR2 is provided at a position corresponding to the servo band SB2. The data elements DRW1 to DRW8 are provided between the servo pattern reading elements SR1 and SR2. The data elements DRW1 to DRW8 are arranged at equal intervals along the width direction WD of the magnetic tape 12. The data elements DRW1 to DRW8 simultaneously record data and/or read data with respect to eight data tracks DT1, DT2, DT3, DT4, DT5, DT6, DT7, and DT8.

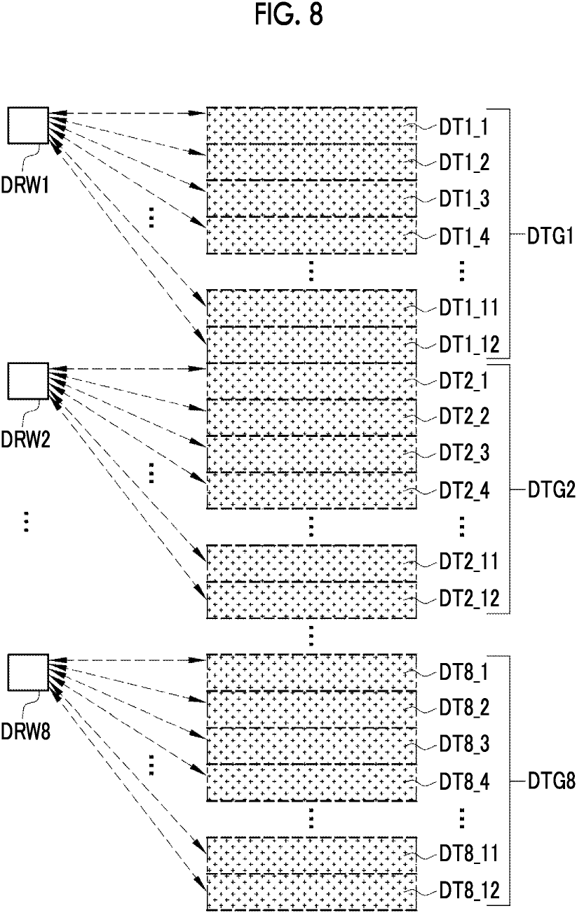

As shown in FIG. 8 as an example, the data element DRW1 is in charge of recording data on a data track group DTG1 composed of a total of 12 data tracks DT, that is, data tracks DT1_1, DT1_2, DT1_3, DT1_4, ..., DT1_11, and DT1_12. In addition, the data element DRW1 is in charge of reading data recorded on the data track group DTG1. Similarly, the data element DRW2 is in charge of recording data on a data track group DTG2, which is composed of data tracks DT2_1 to DT2_12, and of reading data recorded on the data track group DTG2. Hereinafter, similarly, the data element DRW8 is in charge of recording data on a data track group DTG8, which is composed of data tracks DT8_1 to DT8_12, and of reading data recorded on the data track group DTG8. Twelve data tracks DT constituting each of the data track groups DTG1 to DTG8 are arranged at equal intervals along the width direction WD of the magnetic tape 12. The number of data tracks DT included in one data band DB is 8 × 12 = 96. In a case where there is no need to make a particular distinction, the data tracks DT1 to DT8 are collectively denoted as a data track DT.

The data element DRW is shifted to a position corresponding to one designated data track DT out of 12 data tracks with the movement of the magnetic head 28 in the width direction WD performed by the moving mechanism 40. The data element DRW stays at a position corresponding to one designated data track DT through the servo control using the servo pattern 50.

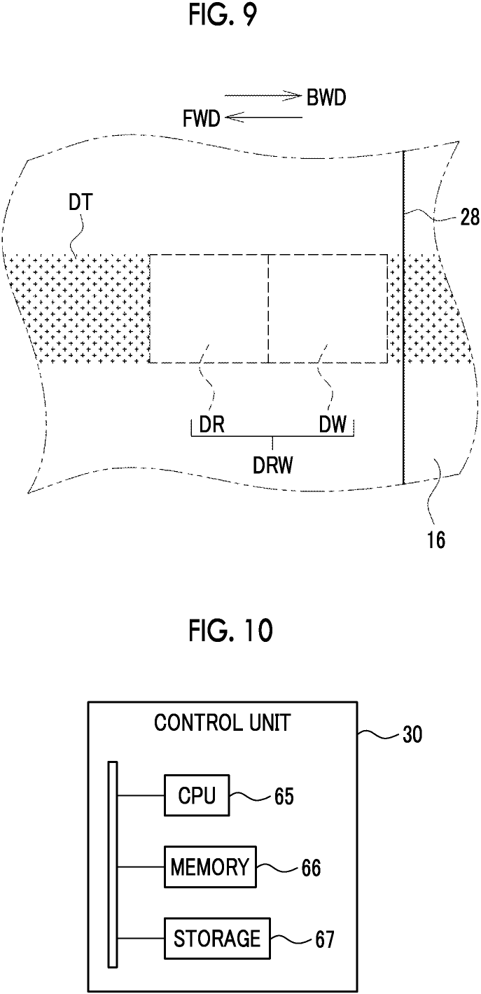

As shown in the enlarged view of FIG. 9, the data element DRW includes a data recording element DW and a data reading element DR. The data recording element DW records data on the data track DT. The data reading element DR reads the data recorded on the data track DT.

The data recording element DW is disposed on an upstream side of the feed direction FWD, and the data reading element DR is disposed on a downstream side of the feed direction FWD. The reason for such a disposition is that the data reading element DR immediately reads the data recorded by the data recording element DW to check errors in a case where the magnetic tape 12 is running in the feed direction FWD.

As shown in FIG. 10 as an example, the control unit 30 is realized by, for example, a computer including a central processing unit (CPU) 65, a memory 66, and a storage 67. The memory 66 is, for example, a random access memory (RAM) or the like and temporarily stores various types of information. The storage 67, which is a non-transitory storage medium, is, for example, a hard disk drive or a solid state drive and stores various parameters and various programs. The CPU 65 loads the program stored in the storage 67 into the memory and executes processing in accordance with the program, thereby controlling the operation of each unit of the magnetic tape device 10 in an integrated manner. The CPU 65 is an example of the “processor” according to the technology of the present disclosure.

In FIG. 11, the CPU 65 executes an operation program 69 stored in the storage 67 to function as a running control unit 70, a position detection unit 71, a servo control unit 72, a position adjustment control unit 73, a data acquisition unit 74, a recording control unit 75, a read control unit 76, and a data output unit 77.

The running control unit 70 controls the drive of the feeding motor 25 and the winding motor 26 to cause the magnetic tape 12 to run in the feed direction FWD or the rewind direction BWD. Further, the running control unit 70 adjusts the rotational speed and the rotational torque of the feeding motor 25 and the winding motor 26 to adjust the tension during running and the running speed of the magnetic tape 12 to appropriate values.

A servo signal based on the servo pattern 50 read by the servo pattern reading element SR of the magnetic head 28 is input to the position detection unit 71. The servo signal is intermittent pulses corresponding to the magnetization regions 51A and 51B. The position detection unit 71 detects the position of the servo pattern reading element SR in the servo band SB in the width direction WD, that is, the position of the magnetic head 28 in the width direction WD with respect to the magnetic tape 12, on the basis of a pulse interval of the servo signal. The position detection unit 71 outputs the detection result of the position of the magnetic head 28 in the width direction WD to the servo control unit 72.

Two types of servo signals based on the servo patterns 50 read by two servo pattern reading elements SR are input to the position detection unit 71. The position detection unit 71 calculates the average value of the pulse intervals of two types of servo signals. Then, the position detection unit 71 detects the position of the magnetic head 28 in the width direction WD, on the basis of the calculated average value.

The servo control unit 72 compares the detection result of the position of the magnetic head 28 from the position detection unit 71 with a target position of the magnetic head 28. In a case where the detection result is the same as the target position, the servo control unit 72 does nothing. In a case where the detection result is displaced from the target position, the servo control unit 72 outputs a servo control signal for making the position of the magnetic head 28 match the target position, to the moving mechanism 40. The moving mechanism 40 operates so as to make the position of the magnetic head 28 match the target position according to the servo control signal. The target position is stored in the storage 67, for example, in the form of a data table in which the values corresponding to the respective data tracks DT1 to DT8 are registered.

The position adjustment control unit 73 reads out the variation profile data 80 from the storage 67. The variation profile data 80 is data representing variations of the magnetic tape 12 in the normal direction ND. The position adjustment control unit 73 controls the operation of the piezoelectric bimorph element 56 by outputting a position adjustment control signal based on the variation profile data 80 to the piezoelectric bimorph element 56. Specifically, the position adjustment control signal is a signal for designating a voltage to be applied to the piezoelectric bimorph element 56.

The data acquisition unit 74 reads out and acquires data to be recorded on the data band DB1 or DB2 by the magnetic head 28 from, for example, a host computer (not shown) connected to the magnetic tape device 10. The data acquisition unit 74 outputs the data to the recording control unit 75.

The recording control unit 75 encodes the data output from the data acquisition unit 74 into a digital signal for recording. Then, the recording control unit 75 causes a pulse current corresponding to the digital signal to flow into the data recording element DW of the magnetic head 28, and causes the data recording element DW to record the data on the designated data track DT of the data band DB1 or DB2.

The read control unit 76 controls the operation of the data reading element DR of the magnetic head 28 to cause the data reading element DR to read the data recorded on the designated data track DT of the data band DB1 or DB2. The data read by the data reading element DR is a pulse-shaped digital signal. The read control unit 76 outputs this pulse-shaped digital signal to the data output unit 77.

The data output unit 77 decodes the pulse-shaped digital signal output from the read control unit 76 to obtain data. The data output unit 77 outputs the data to, for example, the host computer.

As shown in FIG. 12, the variation profile data 80 is data in which an amount of displacement corresponding to a position of the magnetic tape 12 in the length direction (denoted as a magnetic tape position in FIG. 12) is registered. The amount of displacement is an amount of displacement of the magnetic tape 12 from the regular position. The position of the magnetic tape 12 in the length direction is specified by, for example, the servo pattern 50. The amount of displacement of the magnetic tape 12 from the regular position is set as a positive value in a case where the position of the magnetic tape 12 is displaced in the direction of the magnetic head 28 from the regular position, and is set as a negative value in a case where the position of the magnetic tape 12 is displaced in a direction opposite to the magnetic head 28 from the regular position. The position adjustment control unit 73 outputs, to the piezoelectric bimorph element 56, the position adjustment control signal of a content that the amount of displacement of the magnetic tape 12 from the regular position is offset by adjusting the position of the magnetic element ME in the normal direction ND.

The variation profile data 80 is acquired by a test run of the magnetic tape 12 in the feed direction FWD prior to recording data on the magnetic layer 16 and/or reading data recorded on the magnetic layer 16. The amount of displacement of the magnetic tape 12 from the regular position is converted from the measurement result of the distance sensor 39 attached to the support member 29A on the distance to the front surface 18 of the magnetic tape 12. The magnetic tape 12 is caused to test run by bringing the magnetic element ME into contact with the magnetic layer 16, and a voltage generated in the piezoelectric bimorph element 56 according to the variation of the position of the magnetic tape 12 is measured, whereby the amount of displacement of the magnetic tape 12 from the regular position may be converted from the measurement result of the voltage. Alternatively, the amount of displacement of the magnetic tape 12 from the regular position may be converted from the strength of the magnetic field of the magnetic tape 12 sensed by the magnetic element ME.

In a case where the cartridge 11 is of an irreplaceable type installed in the magnetic tape device 10, the variation profile data 80 is acquired at the factory at the time of shipment of the magnetic tape device 10. In a case where the cartridge 11 is of a replaceable type, the variation profile data 80 is acquired when the cartridge 11 is first loaded.

The variation profile data 80 may be acquired in two types, one for the feed direction FWD and the other for the rewind direction BWD, by causing the magnetic tape 12 to test run not only in the feed direction FWD but also in the rewind direction BWD. In addition, the variation profile data 80 may be used without being updated once the variation profile data 80 has been acquired, or may be updated periodically. Further, the variation profile data 80 may be corrected in consideration of variation factors of the temporal spacing SP, such as aged deterioration of the magnetic tape 12 and/or the magnetic element ME. Further, the variation profile data 80 may be corrected in consideration of variation factors of the spacing SP of the ambient environment, such as thermal deformation of the magnetic tape 12 and/or the magnetic element ME. Furthermore, in a case where the cartridge 11 is replaceable, the variation profile data 80 may be stored in a radio frequency (RF) tag incorporated in the cartridge 11, instead of the storage 67. The variation profile data 80 may be predicted by simulation or derived using a machine learning model.

Hereinafter, the action of the above-described configuration will be described with reference to the flowchart of FIG. 13. First, under the control of the running control unit 70, the feeding motor 25 and the winding motor 26 are operated, and the magnetic tape 12 runs in the feed direction FWD or the rewind direction BWD. With this, as shown in FIG. 2, the magnetic tape 12 runs while the front surface 18 of the magnetic tape 12 is slid on the sliding surfaces 38A and 38B of the support members 29A and 29B.

As shown in FIGS. 6A to 6C and the like, the position adjustment control unit 73 controls the operation of the piezoelectric bimorph element 56 on the basis of the variation profile data 80 to move the magnetic head 28, thereby adjusting the position of the magnetic element ME in the normal direction ND (step ST100).

Then, the magnetic element ME is caused to act on the magnetic layer 16 of the magnetic tape 12 (step ST110). Specifically, the servo pattern 50 is read by the servo pattern reading element SR. Further, data is recorded on the data track DT by the data recording element DW under the control of the recording control unit 75. Furthermore, the data recorded on the data track DT is read by the data reading element DR under the control of the read control unit 76.

The position detection unit 71 detects the position of the magnetic head 28 in the width direction WD from the interval of the servo signals based on the servo patterns 50. The servo control unit 72 compares the detection result of the position of the position detection unit 71 with the target position, and performs the servo control for making the position of the magnetic head 28 match the target position.

As described above, the magnetic tape device 10 comprises the magnetic head 28, the piezoelectric bimorph element 56, and the CPU 65. The magnetic head 28 has the magnetic element ME that acts on the magnetic layer 16 formed on the front surface 18 of the magnetic tape 12. The piezoelectric bimorph element 56 adjusts the position of the magnetic element ME in the normal direction ND of the front surface 18 of the magnetic tape 12 by moving the magnetic head 28. The position adjustment control unit 73 of the CPU 65 controls the operation of the piezoelectric bimorph element 56. Therefore, the position of the magnetic element ME in the normal direction ND can be adjusted. Accordingly, it is possible to maintain the positional relationship between the magnetic layer 16 and the magnetic element ME in the normal direction ND, that is, the spacing SP in this example.

As shown in FIG. 2, the magnetic head 28 causes the magnetic element ME to act in proximity to the magnetic layer 16. In this case, maintaining the spacing SP is essential for stabilizing recording and/or reading data. For this reason, in a case where the magnetic element ME is caused to act in proximity to the magnetic layer 16, the usefulness of the technology of the present disclosure is high as compared with a case where the magnetic element ME acts by coming into contact with the magnetic layer 16.

As shown in FIG. 3, the width W_H of the magnetic head 28 is smaller than the width W_T of the magnetic tape 12. Since the weight is lighter than that of a magnetic head having a width W_H equal to or more than the width W_T, the response speed of the movement in the width direction WD in the servo control and the response speed of the movement in the normal direction ND in the position adjustment control are high. Therefore, good followability can be obtained in the servo control and the position adjustment control.

Here, in the conventional magnetic head for a hard disk drive, a method (TFC; thermal flying-height control) of maintaining the spacing SP through thermal expansion or thermal contraction of the magnetic element ME has been employed. However, the amount of variation of the magnetic element ME using heat is at most several nm. Meanwhile, in this example, the piezoelectric element, particularly the piezoelectric bimorph element 56, is used as the position adjusting actuator. In the piezoelectric bimorph element 56, the bending amount ΔL is on the order of several µm, as obtained by Equation (1). Therefore, it is possible to sufficiently respond to the positional variation of the magnetic tape 12 in the normal direction ND on the order of several tens of nm to several µm.

As shown in FIGS. 11 and 12, the position adjustment control unit 73 controls the operation of the piezoelectric bimorph element 56 on the basis of the variation profile data 80 representing the variation of the magnetic tape 12 in the normal direction ND. Therefore, it is possible to easily and reliably maintain the positional relationship between the magnetic layer 16 and the magnetic element ME in the normal direction ND, as compared with a case where the variation of the magnetic tape 12 in the normal direction ND is measured in real time and the operation of the piezoelectric bimorph element 56 is controlled on the basis of the measurement result. The variation of the magnetic tape 12 in the normal direction ND may be measured in real time without referring to the variation profile data 80, and the operation of the piezoelectric bimorph element 56 may be controlled on the basis of the measurement result.

As shown in FIG. 2, the magnetic tape device 10 comprises the pair of support members 29A and 29B disposed on both sides of the magnetic tape 12 in the running direction with the magnetic head 28 interposed therebetween. The front surface 18 of the magnetic tape 12 is slid on the support members 29A and 29B. Therefore, the variation of the magnetic tape 12 in the normal direction ND can be suppressed, and the adjustment of the position of the magnetic element ME in the normal direction ND performed by the piezoelectric bimorph element 56 can be minimized. Further, even in a case where foreign matter is generated because of, for example, scrapes of the magnetic layer 16 caused by contact between the magnetic element ME and the magnetic layer 16, the foreign matter falls between the support members 29A and 29B while the magnetic tape 12 is running. Therefore, the effect of removing the foreign matter can also be expected.

As shown in FIG. 7, the magnetic head 28 has, as the magnetic element ME, the data element DRW that acts on the data band DB and the servo pattern reading element SR that reads the servo pattern 50. As shown in FIG. 9, the data element DRW includes the data recording element DW that records data on the magnetic layer 16 and the data reading element DR that reads the data recorded on the magnetic layer 16. Therefore, it is possible to smoothly perform the reading of the servo pattern 50, and the data recording and the data reading. The data element DRW may be any one of the data recording element DW or the data reading element DR.

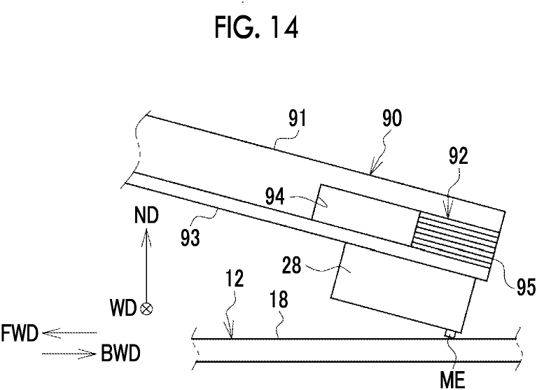

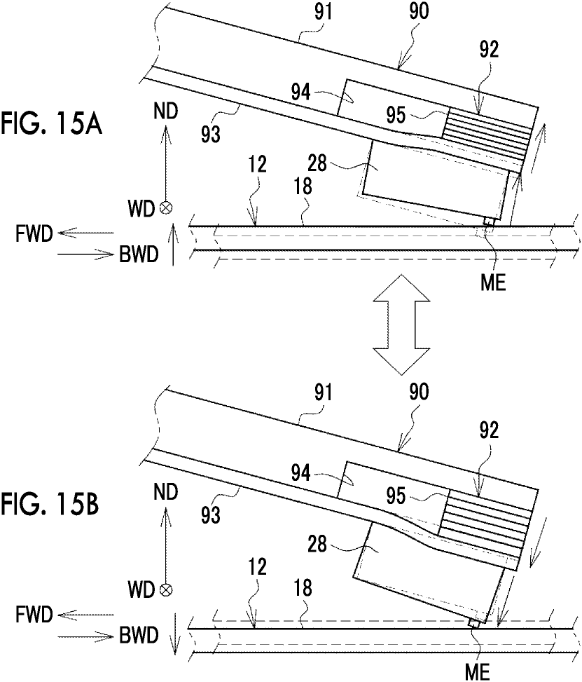

The position adjusting actuator and the piezoelectric element are not limited to the illustrated piezoelectric bimorph element 56. A laminated piezoelectric element 92 shown in FIGS. 14 and 15 may be used.

In FIG. 14, a suspension 90 has a load beam 91, the laminated piezoelectric element 92, a flexure 93, and the like. A notch 94 is formed at a distal end of the load beam 91, and the laminated piezoelectric element 92 is accommodated in the notch 94. The laminated piezoelectric element 92 has a configuration in which a plurality of piezoelectric bodies 95 are laminated, and expands and contracts in a thickness direction by a voltage applied. One end of the laminated piezoelectric element 92 in the thickness direction is fixed to the distal end of the load beam 91, and the other end thereof is fixed to a distal end of the flexure 93. The magnetic head 28 is attached to a surface of the flexure 93 opposing a surface to which the laminated piezoelectric element 92 is attached.

As shown in FIGS. 15A and 15B, the laminated piezoelectric element 92 bends the distal end of the flexure 93 with the expansion and contraction in the thickness direction to move the magnetic head 28, thereby adjusting the position of the magnetic element ME in the normal direction ND. The laminated piezoelectric element 92 operates so as to keep the spacing SP constant under the control of the control unit 30, as in the piezoelectric bimorph element 56. Specifically, in a case where the position of the magnetic tape 12 is displaced in the direction of the magnetic head 28 from the regular position shown in FIG. 14, the laminated piezoelectric element 92 contracts in the thickness direction as shown in FIG. 15A. On the other hand, in a case where the position of the magnetic tape 12 is displaced in the direction opposite to the magnetic head 28 from the regular position shown in FIG. 14, the laminated piezoelectric element 92 expands in the thickness direction as shown in FIG. 15B. In this way, even with the laminated piezoelectric element 92, it is possible to adjust the position of the magnetic element ME in the normal direction ND, and it is possible to maintain the positional relationship between the magnetic layer 16 and the magnetic element ME in the normal direction ND.

As the position adjusting actuator, in addition to the piezoelectric element, bimetal in which two metal plates having different thermal expansion factors are bonded to each other, a shape memory alloy, or the like may be used.

The aspect in which the magnetic element ME is caused to act in proximity to the magnetic layer 16 has been illustrated, but the technology of the present disclosure is not limited thereto. The magnetic element ME may act by coming into contact with the magnetic layer 16. However, it is preferable to employ the aspect in which the magnetic element ME is caused to act in proximity to the magnetic layer 16 because the magnetic layer 16 is scraped off to generate foreign matter or the magnetic element ME is worn by an abrasive prescribed for the magnetic layer 16, in a case where the magnetic element ME is brought into contact with the magnetic layer 16.

The number of servo bands SB, the number of data bands DB, the number of data elements DRW, the number of data tracks DT that one data element DRW is in charge of, and the like shown above are merely an example, and the technology of the present disclosure is not particularly limited thereto.

For example, a magnetic tape in which five servo bands SB and four data bands DB are alternately arranged along the width direction WD may be used. Further, a magnetic tape in which nine servo bands SB and eight data bands DB are alternately arranged along the width direction WD may be used. Alternatively, a magnetic tape in which 13 servo bands SB and 12 data bands DB are alternately arranged along the width direction WD may be used.

One magnetic head 28 is shared between the feed direction FWD and the rewind direction BWD, but a magnetic head for the feed direction FWD (hereinafter, referred to as a feed head) and a magnetic head for the rewind direction BWD (hereinafter, referred to as a rewind head) may be provided. In this case, the magnetic element ME of the feed head performs, for example, the reading of the servo patterns 50 of the servo bands SB1 and SB2 and the recording of data on the data band DB1 and/or the reading of data recorded on the data band DB1, and the magnetic element ME of the rewind head performs, for example, the reading of the servo patterns 50 of the servo bands SB2 and SB3 and the recording of data on the data band DB2 and/or the reading of data recorded on the data band DB2.

The number of servo pattern reading elements SR disposed in one magnetic head may be one. Similarly, the number of data elements DRW disposed in one magnetic head may be one.

The number of data elements DRW disposed in one magnetic head may be, for example, 16, 32, or 64. Further, the number of data tracks DT that one data element DRW is in charge of for data recording and/or data reading is not limited to 12 illustrated above. The number of data tracks DT may be 1 or, for example, 4, 16, 32, or 64.

A pair of support rollers may be used instead of the pair of support members 29A and 29B.

The magnetic tape device 10 in which the cartridge 11 is loaded has been illustrated, but the technology of the present disclosure is not limited thereto. The magnetic tape 12 as it is in which the cartridge 11 is not accommodated may be a magnetic tape device wound on a feed reel, that is, a magnetic tape device in which the magnetic tape 12 is irreplaceably installed.

The magnetic tape 12 is not limited to the magnetic tape having the magnetic layer 16 containing ferromagnetic powder illustrated above. A magnetic tape in which a ferromagnetic thin film is formed by vacuum deposition, such as sputtering, may be used.

The computer constituting the control unit 30 may include, for example, a programmable logic device (PLD) which is a processor whose circuit configuration is changeable after manufacture, such as a field-programmable gate array (FPGA), and/or a dedicated electrical circuit which is a processor having a dedicated circuit configuration designed to execute specific processing, such as an application specific integrated circuit (ASIC), in place of or in addition to the CPU 65.

The technology of the present disclosure can also appropriately combine the above-mentioned various embodiments and/or various modification examples. In addition, it goes without saying that the technology of the present disclosure is not limited to the above embodiments and various configurations may be employed without departing from the gist thereof. Furthermore, the technology of the present disclosure extends to a storage medium having the program non-transitorily stored thereon, in addition to the program.

The contents described and shown above are detailed descriptions of the parts related to the technology of the present disclosure, and are merely an example of the technology of the present disclosure. For example, the descriptions of the above configurations, functions, actions, and effects are the descriptions of an example of the configurations, functions, actions, and effects of the parts related to the technology of the present disclosure. Accordingly, it is needless to say that unnecessary parts may be deleted, new elements may be added, or replacements may be made with respect to the contents described and shown above, without departing from the gist of the technology of the present disclosure. Further, in order to avoid complications and facilitate understanding of the parts related to the technology of the present disclosure, descriptions of common general knowledge and the like that do not require special descriptions for enabling the implementation of the technology of the present disclosure are omitted, in the contents described and shown above.

In the present specification, “A and/or B” has the same meaning as “at least one of A or B”. That is, “A and/or B” means that only A may be used, only B may be used, or a combination of A and B may be used. In addition, in the present specification, the same concept as “A and/or B” is also applied to a case where three or more matters are expressed by “and/or”.

All documents, patent applications, and technical standards described in the present specification are incorporated in the present specification by reference to the same extent as in a case where the individual documents, patent applications, and technical standards were specifically and individually stated to be incorporated by reference.

What is claimed is:

1. A magnetic tape device comprising:
a magnetic head having a magnetic element that acts on a magnetic layer formed on a front surface of a magnetic tape; and
a position adjusting actuator that adjusts a position of the magnetic element in a normal direction of the front surface by moving the magnetic head; and
a processor that controls an operation of the position adjusting actuator.

2. The magnetic tape device according to claim 1,
wherein the magnetic head causes the magnetic element to act in proximity to the magnetic layer.

3. The magnetic tape device according to claim 1,
wherein the magnetic head has a width smaller than a width of the magnetic tape.

4. The magnetic tape device according to claim 1,
wherein the position adjusting actuator is a piezoelectric element.

5. The magnetic tape device according to claim 1,
wherein the processor controls the operation of the position adjusting actuator on the basis of variation profile data representing a variation of the magnetic tape in the normal direction.

6. The magnetic tape device according to claim 1, further comprising:
a pair of support members on which the front surface is slid, the pair of support members being disposed on both sides of the magnetic tape in a running direction with the magnetic head interposed therebetween.

7. The magnetic tape device according to claim 1,
wherein a plurality of data bands on which data is recorded, and a plurality of servo bands on which a plurality of servo patterns used for servo control to move the magnetic head in a width direction of the magnetic tape are recorded are formed in the magnetic layer, and
the magnetic head includes, as the magnetic element, a data element that acts on the data band and a servo pattern reading element that reads the servo patterns.

8. The magnetic tape device according to claim 7,
wherein the data element includes
a data recording element that records the data on the magnetic layer, and
a data reading element that reads the data recorded on the magnetic layer.

9. A method of operating a magnetic tape device, comprising:
adjusting a position of a magnetic element of a magnetic head in a normal direction of a front surface of a magnetic tape by controlling an operation of a position adjusting actuator to move the magnetic head; and
causing the magnetic element to act on a magnetic layer formed on the front surface.
